(19) United States
(12) Patent Application Publication
(10) Pub. No.: US 2002/0022504 A1
(43) Pub. Date: Feb. 21, 2002

(54) Communication device

(76) Inventor: Kazutugu Horii, Kawagoe-shi (JP)

Correspondence Address: SUGHRUE, MION, ZINN, MACKPEAK & SEAS, PLLC, 2100 Pennsylvania Avenue, N.W., Washington, DC, 20037, US

(21) Appl. No.: 09/839,399

(22) Filed: Apr. 23, 2001

(30) Foreign Application Priority Data
Apr. 28, 2000 (JP) P. 2000-131601
Jun. 23, 2000 (JP) P. 2000-190311

(51) Int. Cl. H04B 1/38

(52) U.S. Cl. 455/575; 455/90; 455/566

(57) ABSTRACT

In a communication device, since various pilot switches for detecting the movement of an antenna in respective directions are provided and then the operation for moving appropriately the antenna is executed, the information can be selected easily and thus a series of operations concerning to the communication can be simplified.

### BACKGROUND OF THE INVENTION

1. Field of the Invention

The present invention relates to a communication device for executing the radio communication via an antenna and, more particularly, a communication device in which the operability of various operations executed by the user in communication can be improved.

2. Description of the Related Art

Up to now, as an example of the communications devices that can handle the radio communication via the antenna, there is the mobile radio telephone. Such mobile radio telephone needs a small size to carry, nevertheless the large display area of the display portion such as the liquid crystal panel, etc. provided to display characters such as the telephone numbers of the other party and the image is desired and also multi functions are desired as the radio network terminal. Therefore, in order to reduce the size of the device and assure the necessary display area of the display portion, normally the mobile radio telephone is constructed such that enormous data such as input and search of respective items of the telephone directory list, input or the characters of the E-mail, etc. are assigned to a small number of keys such as the ten key, etc. to select and input them.

Also, in the mobile radio telephone, normally the rod antenna is employed to transmit/receive the radio wave. The rod antenna can be pushed into the inside of the device by the user to improve the convenience of the device in carrying, and also the rod antenna being pushed into the inside of the device can be pulled out to the outside of the device as occasion demands.

The user can always carry the mobile radio telephone while setting it into the standby state to wait the calling from the other party by turning on the power supply of the mobile radio telephone after the antenna is collapsed into the inside of the device. When the call made by the ringing tone is accepted from the telephone of the other party, the user can talk with the other party by pushing the talk button provided to the operation panel, etc. of the device so as to connect the line to the calling telephone of the other party, and then pulling out the antenna from the device main body to the outside so as to improve the receiving sensitivity in talking.

Also, if the user wishes to call the desired other party from the mobile radio telephone that is in the non-operating state, he or she can put through a call to the telephone of the desired destination by first executing the key operation required to talk with the destination such as input or selection of the telephone number of the destination, etc. after the power supply of the device is turned on, and then pushing the talk button after the antenna is pulled out to the outside of the device.

However, as described above, since the key operations necessary for the talking with the destination are assigned to the small-numbered keys in the mobile radio telephone, such key operations executed by the user become very troublesome.

More particularly, for example, if the user selects the telephone number of the destination by searching the telephone directory list, he or she must select the desired telephone number by displaying the telephone directory list on the display portion, and then pushing the UP key, the DOWN key, etc. appropriately at plural numbers of times to scroll vertically the list every time. Therefore, an amount of data of the telephone directory list is increased as the telephone numbers of the destination registered on the telephone directory are increased more and more. For this reason, when the desired destination is selected from the list, the number of times to push the keys such as the UP key, the DOWN key, etc. is increased, and thus much time is expanded on the selection.

Also, if the character input of the mail is executed, in many cases the ten-key is assigned as the character input keys. For example, rows of the Japanese hiragana syllabary are assigned to be selected by the number key respectively such that, for example, a “A” row is assigned to the “1” key, a “KA” row is assigned to the “2” key, and so on. Thus, the hiragana on the row corresponding to the concerned number key is displayed sequentially every time when the number key is pushed one time, and thus the desired telephone number can be selected. Therefore, the key operations of a considerable number of times are requested to input merely five characters of “KO-N-NI-CHI-WA” (hellow in English), for example. Also, if the desired character is passed through erroneously, the correcting operation must be executed by repeating the pushing operation of the number key subsequently to circulate and display the characters on the concerned row. As a result, the time required to select the characters is further expanded.

In this manner, in the prior art, if the user wishes to call the desired destination by using the mobile radio telephone, the antenna provided at the location remote from the operation keys must be pulled out from the inside of the device to the outside and also the talk button must be pushed in addition to the troublesome key operation executed by the above few operation keys. As a result, a series of operations required to talk with the other party via the telephone become troublesome and inconvenience.

### SUMMARY OF THE INVENTION

The present invention has been made in view of the above problems, and it is an object of the present invention to provide a communication device capable of performing easily a series of operations required of the user for the communication of the device.

To achieve the above object, according to a first aspect of the invention, there is provided a communication device that comprises an antenna; an antenna supporting portion for supporting rotatably the antenna in a device; a gear provided coaxially and integrally with the antenna; and a turn detecting means engaged with the gear to detect a turn of the antenna.

According to the first aspect of the invention, since the antenna is supported rotatably by the antenna supporting portion in the device and also the turn of the antenna can be detected by the turn detecting means, the user can select the information by utilizing the turn of the antenna.

Also, according to a second aspect of the invention, the communication device according to the first aspect further comprises a housing portion which can push the antenna into an inside of the device; and wherein the gear engages with the turn detecting means in a folding state of the antenna and a non-folding state of the antenna.

Also, according to a third aspect of the invention, there is provided a communication device that comprises an antenna supported rotatably in the device; and a movement detecting means for detecting a movement of the antenna; wherein information is selected in response to a moving direction or an amount of movement of the antenna based on a movement detected result.

According to the third aspect of the invention, since the movement detecting means detects the moving direction or the amount of movement of the antenna, the user can select a plurality of information in response to the movement of the antenna.

Also, according to a fourth aspect of the invention, there is provided a communication device that comprises an antenna supported rotatably in the device; and a turn detecting means for detecting a turn of the antenna; wherein information is selected in response to a turning direction or an amount of turn or a turning speed of the antenna based on a turn detected result.

According to the fourth aspect of the invention, since the information can be selected in response to the turn of the antenna, a series of key operations required to select the information can be simplified.

Also, according to a fifth aspect of the invention, there is provided a communication device that comprises an antenna supported rotatably in the device; and a movement detecting means for detecting a movement of the antenna; wherein information is searched in response to a turning direction or an amount of turn or a turning speed of the antenna based on a turn detected result, and information is selected in response to a moving direction or an amount of movement of the antenna in a turning axis direction based on a movement detected result.

According to the fifth aspect of the invention, since the search and selection of the information are executed by different operations, a series of operations required to search and select the information can be simplified much more.

Also, according to the sixth aspect of the invention, in the communication device according to the third to fifth aspects, communication is carried out in response to the selection of the information.

### BRIEF DESCRIPTION OF THE DRAWINGS

FIGS. 1A to 1C are views showing a mobile radio telephone P1 as a communication device according to a first embodiment of the present invention;

FIGS. 2A and 2B are views showing a principal structure of a guide portion;

FIG. 3 is a sectional view showing a star gear that engages with a pilot switch;

FIGS. 4A to 4C are views showing a mobile radio telephone P2 according to a second embodiment of the present invention.;

FIGS. 5A and 5B are views showing a pilot switch;

FIGS. 6A and 6B are views showing a mobile radio telephone P3 according to a third embodiment of the present invention;

FIGS. 7A and 7B are views showing a principal structure of a mobile radio telephone P4 according to a fourth embodiment of the present invention;

FIGS. 8A and 8B are views showing a principal structure around a pilot switch of a mobile radio telephone P5 according to a fifth embodiment of the present invention; and

FIG. 9 is a view showing another embodiment of a turn detecting means in the present invention.

### DETAILED DESCRIPTION OF THE PREFERRED EMBODIMENTS

Next, preferred embodiments of the present invention will be explained with reference to the accompanying drawings hereinafter.

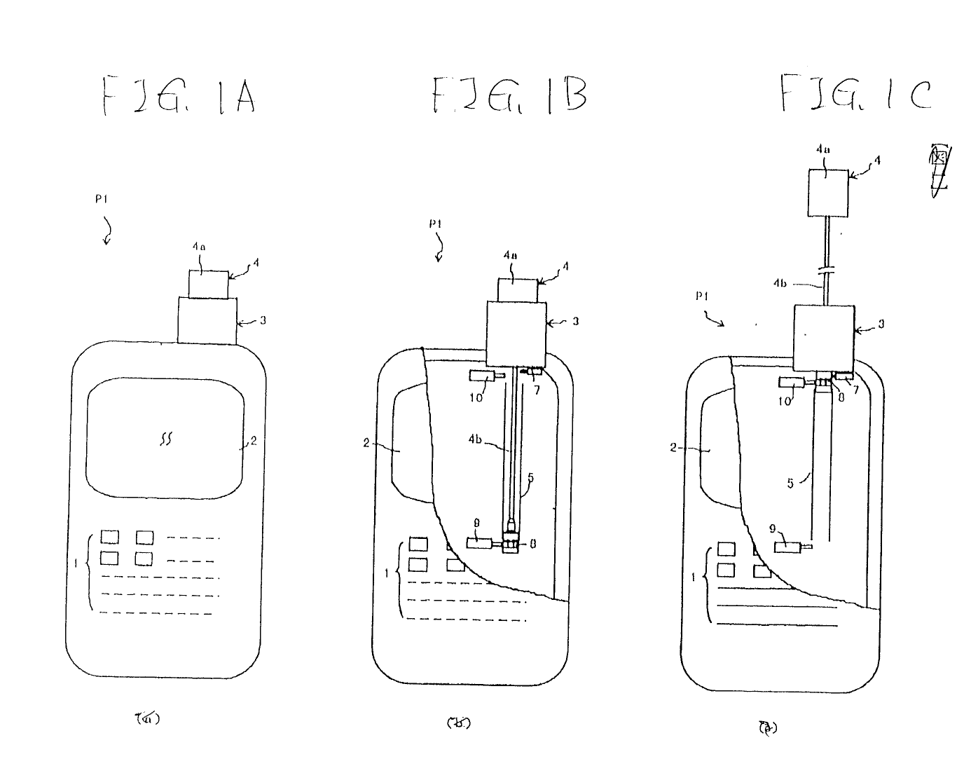

FIGS. 1A to 1C are views showing a mobile radio telephone P1 as a communication device according to a first embodiment of the present invention. FIG. 1A is a view showing an appearance of the mobile radio telephone P1 when the antenna is at the pushed-in position. FIG. 1B is a view showing the mobile radio telephone P1 together with a part of the inside thereof when the antenna is positioned at the antenna folding position. FIG. 1C is a view showing the mobile radio telephone P1 together with a part of the inside thereof when the antenna is at the pulled-out position. The mobile radio telephone P1 comprises a key pad 1, a display portion 2, a guide portion 3, an antenna 4, a slide guide 5, a pilot switch 7, a star gear 8, a pilot switch 9, and a pilot switch 10.

The key pad 1 and the display portion 2 are provided on the front surface of the mobile radio telephone P1. A power supply button for turning on/off the power supply, a ten-key for inputting the telephone number, etc., switching buttons for switching various function such as the telephone directory function, the electronic mail function, etc. (a scroll key, four cursor keys for moving a cursor displayed on the display portion independently in four directions in upper/lower and left/right directions, etc.), a memory key for registering various information such as the characters of the names and the telephone numbers of the other parties in the telephone directory list, a talk button for starting the talking, etc. are provided on the key pad 1. Also, the display portion 2 consists of the liquid crystal panel, for example, and displays contents of the telephone directory list and the electronic mail thereon.

The antenna 4 is formed as a rod antenna consisting of an almost cylindrical head portion 4a, and a metal rod 4b formed subsequently to this head portion 4a to have a circular sectional shape. The head portion 4a is positioned by inserting the metal rod 4b into the guide portion 3 provided to the mobile radio telephone P1. The antenna 4 can be pushed into the antenna folding position (see FIG. 1B) when the metal rod 4b is pushed into the inside of the device by the user's manual operation. Also, the antenna 4 can be pulled out from the antenna folding position to the antenna extending position (see FIG. 1C). In this case, the antenna 4 can be supported rotatably around almost the axis of the metal rod 4b by the guide portion 3 and the slide guide 5 on both the antenna folding position and the antenna extending position.

The slide guide 5 has a pipe-like shape and provided in the inside of the telephone P1 to support the antenna 4 movably from the antenna folding position to the antenna extending position. If the antenna 4 is moved from the antenna folding position to the antenna extending position, the antenna 4 is guided by the guide portion 3 and also the lower end portion of the metal rod 4b of the antenna 4 is guided by the slide guide 5 to move in the vertical direction, i.e., the horizontal direction to the turning axis of the antenna 4.

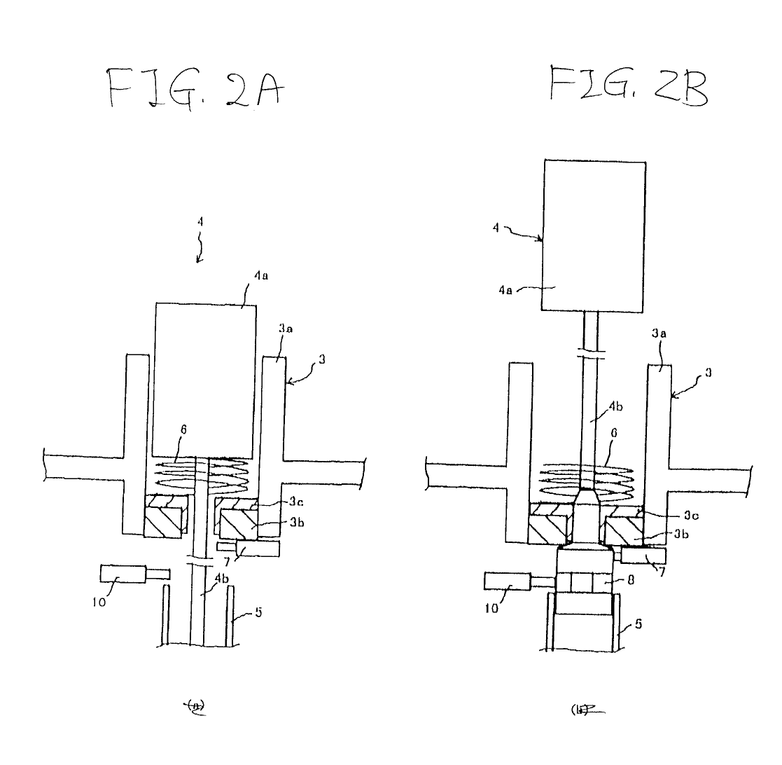

FIGS. 2A and 2B are views showing a principal structure of the guide portion 3. FIG. 2A is a sectional view showing the guide portion 3 when the antenna 4 is positioned at the antenna folding position, and FIG. 2B is a sectional view showing the guide portion 3 when the antenna 4 is positioned at the antenna extending position. As shown in FIGS. 2A and 2B, the guide portion 3 is constructed by fixing a metal nut 3b and a fitting screw 3c to the lower end portion of a hollow cylinder portion 3a, into which a part of a head portion 4a of the antenna 4 is pushed, in respectively and fitting a coil spring 6 onto the fitting screw 3c. The metal nut 3b is connected to a radio wave input/output terminal of a transmitting/receiving portion (not shown) provided to the telephone P1. Also, a hole through which the metal rod 4b is passed is provided to the center portion of the fitting screw 3c.

If the antenna 4 is pushed into the inside of the device from the outside of the device by the user and collapsed into the antenna folding position, for example, the head portion 4a is collapsed into the hollow portion of the hollow cylinder portion 3a. At this time, the bottom portion of the head portion 4a comes into contact with an elastic spring 6, and is positioned at a predetermined height position from the top portion of the fitting screw 3c by a restoring force of the elastic spring 6. Thus, the antenna 4 is positioned at the antenna folding position. In contrast, if the antenna 4 is pulled out from the inside of the device to the outside of the device, the lower end portion of the metal rod 4b is fitted into a center hole of the fitting screw 3c and then latched by it, as shown in FIG. 2B. Thus, the antenna 4 is positioned at the antenna extending position and then held by the fitting screw 3c. In this case, as shown in FIG. 2B, when the antenna 4 is positioned at the antenna extending position, the metal rod 4b comes into contact with the metal nut 3b, and thus the antenna 4 is connected to the radio wave input/output of the terminal transmitting/receiving portion.

Also, the pilot switch 7 is an ON/OFF switch provided to detect whether or not the antenna 4 is positioned at the antenna extending position, and is provided near the top end of the slide guide 5 in the telephone P1, as shown in FIGS. 1A to 1C.

If the antenna 4 is pulled out to the antenna extending position, the pilot switch 7 is pushed by the lower end portion of the antenna 4 and brought into its ON state, as shown in FIG. 2B. Therefore, if a control portion (not shown) of the device detects this state, it can detect that the antenna 4 is positioned at the antenna extending position.

In addition, the star gear 8 is a pillar-like gear having a star-like sectional shape in which a plurality of equally-shaped projections that correspond to teeth of the gear are uniformly arranged radially from the axis of the gear. As shown in FIG. 2B, the star gear 8 is fixed to the lower end portion of the metal rod 4b, and is formed such that it can be moved together with the antenna 4 from the antenna folding position to the antenna extending position. Accordingly, when the antenna 4 is positioned at both the antenna folding position and the antenna extending position, the star gear 8 can be turned integrally with the antenna 4.

The pilot switch 9 and the pilot switch 10 are a switch that detects the turn of the antenna 4 respectively and, as shown in FIGS. 1A to 1C, are provided to the lower end portion and the upper end portion of the slide guide 5 in the telephone P1 respectively. Since the pilot switch 9 engages with the star gear 8 to detect the turn of the star gear 8 when the antenna 4 is positioned at the antenna folding position, it can detect the turn of the antenna 4 that is positioned together with the star gear 8. Also, since the pilot switch 10 engages with the star gear 8 to detect the turn of the star gear 8 when the antenna 4 is positioned at the antenna extending position, it can detect the turn of the antenna 4 that is positioned together with the star gear 8.

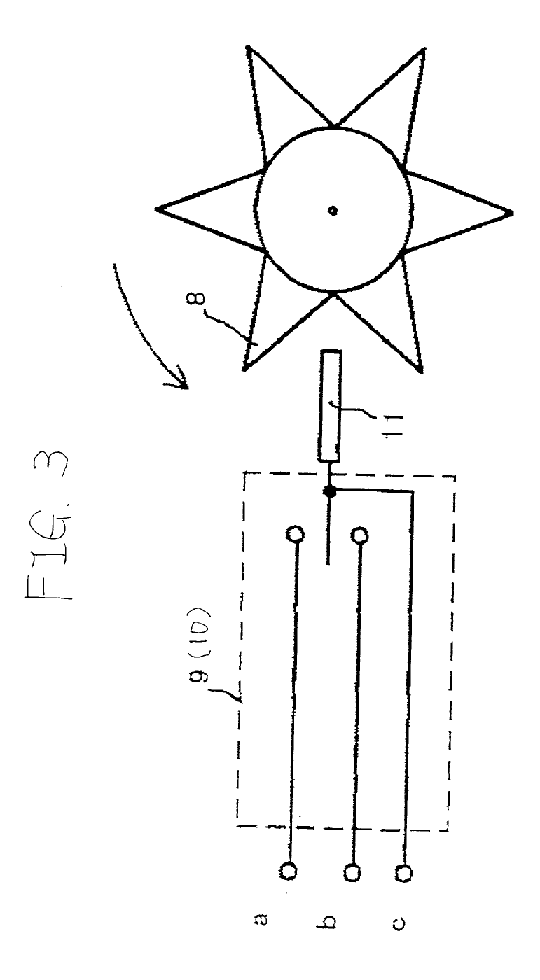

FIG. 3 is a sectional view showing the star gear 8 that engages with the pilot switch 9 (or the pilot switch 10). As shown in FIG. 3, the pilot switch 9 and the pilot switch 10 are constructed by a two circuit selecting switch that can detects the turn of the antenna 4 in the forward direction and the reverse direction respectively. A lever 11 is provided to the pilot switch 9 and the pilot switch 10 respectively. The star gear 8 engages with the lever 11 of the pilot switch 9 when the antenna 4 is positioned at the antenna folding position, and the star gear 8 engages with the lever 11 of the pilot switch 10 when the antenna 4 is positioned at the antenna extending position. The levers 11 of the pilot switches 9, 10 are always connected to respective terminals c. When the engaged lever 11 is pushed intermittently and sequentially by a plurality of star projection portions in response to the turn of the engaged star gear 8, the terminal a or the terminal c is selected every time and thus the circuit selection is carried out intermittently.

More particularly, if the star gear 8 is turned in the direction indicated by an arrow (anticlockwise direction) shown in FIG. 3, the lever 11 is sequentially pushed by the star projection portions of the star gear 8 according to the turn of the star gear 8 and thus is connected/disconnected to/from the terminal a. As a result, the terminal a and the terminal c are circuit-connected intermittently. In contrast, if the star gear 8 is turned in the direction indicated by an arrow (the clockwise direction) shown in FIG. 3, the lever 11 is sequentially pushed by the star projection portions of the star gear 8 according to the turn of the star gear 8 and thus is connected/disconnected to/from the terminal b.

That is, since the pilot switch 9 and the pilot switch 10 can perform any circuit selection to the terminal a or the terminal c intermittently by using the lever 11, they can detect the turn of the star gear 8 every time. In other words, the pilot switch 9 and the pilot switch 10 can detect an amount of turn, i.e., a turn angle of the antenna 4, that corresponds to the number of projections of the star gear 8, in the positive direction every time when the terminal a is connected/disconnected one time, and can detect an amount of turn, i.e., a turn angle of the antenna 4, that corresponds to the number of projections of the star gear 8, in the negative direction every time when the terminal b is connected/disconnected one time. Also, a turning speed of the antenna 4 may be detected by detecting the disconnected numbers of times and the turning time of the terminal a and the terminal b. For example, the turning speed may be calculated based on the disconnected number of times per unit turning time, otherwise the turning speed may be calculated based on the turning time per unit disconnected number of times. In this case, the unit turning time and the unit turn number of times may be set arbitrarily to meet the use conditions.

When the user wishes to increase the speed detecting sensitivity, the unit turning time is set short and also the unit disconnected number of times is reduced. In contrast, when the user wishes to decrease the speed detecting sensitivity, the unit turning time is set long and also the unit disconnected number of times is increased. The fine recognition of the speed change can be achieved when the sensitivity is increased, whereas the smooth speed detection can be attained without the abrupt speed change when the sensitivity is decreased.

As a result, the control portion (not shown) of the mobile radio telephone P1 can detect sequentially the turning direction of the antenna 4, and the amount of turn and the turning speed in this direction based on the detection output of the pilot switch 9 or the pilot switch 10.

As described above, in the mobile radio telephone P1, the movement of the antenna 4 can be detected by the pilot switches provided to the telephone P1. In other words, the pilot switch 7 can detect whether or not the antenna 4 is positioned at the antenna extending position in the vertical moving direction of the antenna 4, and the pilot switch 9 and the pilot switch 10 can detect the amount of turn, etc. of the antenna 4 when the antenna 4 is positioned at the antenna folding position and the antenna extending position respectively.

As a result, the mobile radio telephone P1 assigns the role of the selecting means, that selects various functions described later to operate, to the antenna 4 by utilizing the detected results of the above pilot switches. That is, since the control portion (not shown) of the telephone P1 executes the control based on the detection results of the detecting means, various functions can be selected and operated in response to the above moving operation of the antenna 4.

Next, the respective functions of the device P1 in response to respective moving operations of the antenna 4 will be explained hereunder.

(Function in Response to the Vertically Moving Operation of the Antenna 4)

(1) Talking Function in the Call Outgoing and the Call Incoming of the Telephone

The telephone P1 can be set to the talking state based on the detection result of the pilot switch 7 when the call is incoming into the telephone, and also the call can be transmitted from the telephone P1 to the telephone of the designated destination based on the detection result of the pilot switch 7.

More particularly, if the call incomes by the ringing tone of the telephone from the other party to the telephone P1 in which the antenna 4 as the selecting means is pushed in the antenna folding position and which is set in the standby state, the pilot switch 7 can be switched from OFF to ON when the user executes the operation to pull out the antenna 4 in response to the call. Therefore, the control portion can control to talk with the other party by connecting the line to the calling telephone of the other party in response to the output result of the pilot switch 7 in this case.

Also, if the user calls the desired other party, the pilot switch 7 can be switched from OFF to ON when the user executes the operation to pull out the antenna 4 to the antenna extending position. Therefore, the control portion can call the other party by issuing the calling to the telephone of the selected destination in response to the output result of the pilot switch 7 in this case. In this case, the designation of the telephone number of the destination may be conducted before the user executes the operation to pull out the antenna 4 based on the operation of the key pad 1 or the telephone directory list, or may be conducted after the user has pulled out the antenna 4 to the antenna extending position.

With the above operation, the user can talk easily with the calling other party only by pulling out the antenna without the separate pushing of the talk button, and also the user can issue easily the call by calling the designated telephone of the other party without the separate pushing of the talk button.

(2) Function for Interrupting the Telephone Line During Talking

The telephone P1 which is in the talking state with the telephone of the destination can be interrupted from the telephone of the other party by the detection result of the pilot switch 7.

More particularly, the pilot switch 7 can be switched from ON to OFF when the user executes the operation to push in the antenna 4 from the antenna extending position to the inside of the telephone P1 during the talking with the telephone of the destination. Therefore, the control portion can execute the control to interrupt the telephone P1 from the telephone of the destination in response to the output result of the pilot switch 7 in this case. With the above, when the user ends the talking with the destination, he or she can interrupt easily the telephone P1 by executing the simple operation without the separate operation of the talk end button, i.e., by only pushing in the antenna 4 from the antenna extending position into the antenna folding position in the inside of the telephone P1.

(Functions in Response to the Turning Operation of the Antenna 4)

Function of scrolling the telephone directory list:

The telephone directory list being now displayed on the display portion 2 of the telephone P1 can be scroll-selected along any one of the vertical direction and the horizontal direction by executing the turning operation of the antenna 4 as the selecting means. More particularly, while the user is displaying various information of the telephone directory list on the display portion 2 by using the telephone directory function of the telephone P1, for example, the star gear 8 turns in the same direction as the antenna 4 when the user turns the antenna 4 at the antenna folding position or the antenna extending position. Accordingly, if the star gear 8 is positioned at the antenna folding position, such star gear 8 that engages currently with the level 11 of the pilot switch 9 executes the circuit selection intermittently in response to the turning direction of the antenna 4.

As a result, the control portion detects the turning direction of the antenna 4 by detecting that the selected circuit has been connected, and then causes the information of the telephone directory list, that are currently displayed on the display portion 2, to scroll along the direction that corresponds to the turn of the antenna 4. Also, since the control portion 4 detects the number of intermittence of the selected circuit of the antenna 4 while the antenna 4 is turning in the same direction, the amount of turn of the antenna 4 in the direction can be detected and thus the information of the telephone directory list can be scroll-selected by an amount of scroll in response to the amount of turn along any direction of the vertical direction and the horizontal direction.

In other words, since the selection of the information can be implemented in response to the turning direction and the amount of turn of the antenna, the desired information can be selected from a large number of selected objects in a short time. For example, if the telephone directory list is displayed in order of the kana syllabary, in order to select the telephone number of the “YUENCHI” (recreation ground), first the antenna is turned at the high speed to scroll the list at the high speed in answer to the amount of turn. Then, the antenna is turned at the low speed at a point of time when the name of the list approaches “YU”, and thus the “YUENCHI” (recreation ground) can be easily selected from the telephone directory list that scrolls at the low speed in response to the amount of turn. Even when the list being displayed goes past the object name, such list can be easily returned by turning the antenna in the opposite direction since the list is also scrolled in response to the turning direction. Accordingly, the desired name can be easily selected in a short time from the list that contains a number of names.

Also, when the star gear 8 is positioned at the antenna extending position, the star gear 8 that engages currently with the lever 11 of the pilot switch 10 executes the circuit selection intermittently in response to the turning direction of the antenna 4. As a result, like the case where the above star gear 8 is positioned at the antenna extending position, the control portion can detect the turning direction and the amount of turn of the antenna 4, and thus the information of the telephone directory list can be scroll-selected by an amount of scroll in response to the amount of turn along any direction of the vertical direction and the horizontal direction.

Accordingly, if the user transmits or receives the call, he or she can easily execute a series of necessary operations such as the operation for scroll-selecting the telephone directory list by the turning operation, the call-outgoing operation or the call-incoming operation by pulling out the antenna 4 to the antenna extending position, the operation for extending the antenna to improve the communication sensitivity, etc., by merely operating the antenna 4. Therefore, unlike the case of the mobile radio telephone in the prior art, it is possible to eliminate the time and labor that are needed to operate one by one the antenna to pull out, the scroll key for the telephone directory list, the talk button, etc., that are positioned at different places mutually.

Also, if the necessary information should be selected quickly from a large quantity of information like the telephone directory list, it is difficult by the input of the scroll key to increase the scrolling speed and thus it takes much time to select the information. However, since the scrolling speed can be easily changed by using the above turning function of the antenna 4, the information can be selected quickly and easily. That is, the user can execute the selection of the information necessary for the communication to a series of operations necessary for the communication only by operating the antenna.

In the above first embodiment, since the antenna 4 as the selecting means is turned in any one direction of the clockwise direction and the anticlockwise direction to select the information in connection with the communication such as the information of the telephone directory list displayed on the display portion, etc., the turning direction and the amount of turn of the antenna 4 are detected by the pilot switches 9, 10 and then the information can be scroll-selected based on the detection results. In this case, the movement of the antenna 4 in respective directions when the operations to incline the antenna 4 in four directions, i.e., up/down and left/right directions, if viewed from the head portion 4a, are executed may be detected by using the pilot switch, that detects the movement of the antenna 4 in the vertical direction, in place of the pilot switches 9, 10. In this case, the user can scroll quickly and easily various information being displayed on the display portion 2 in any direction of four desired directions by operating the antenna 4 like the joy stick to select appropriately them. An example of such mobile radio telephone will be explained with reference to a second embodiment in the following.

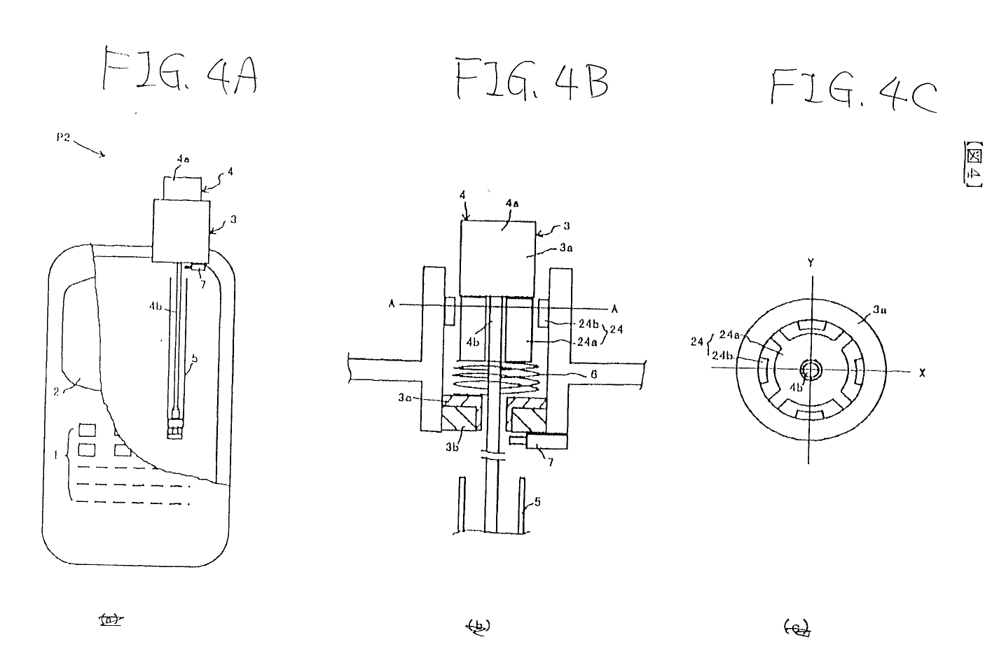

FIGS. 4A to 4C are views showing a principal structure of a mobile radio telephone P2 according to a second embodiment of the present invention. FIG. 4A is a view showing the mobile radio telephone P2 together with a part of the inside of the telephone P2 when the antenna is positioned at the antenna folding position. FIG. 4B is a view showing a principal structure of a pilot switch 24 provided to the mobile radio telephone P2 if viewed from a sectional shape containing the turning axis of the antenna 4 that is positioned at the antenna folding position. FIG. 4C a view showing the pilot switch 24 if viewed along a direction perpendicular to the turning axis of the antenna 4, i.e., an A-A sectional direction shown in FIG. 4B.

In this case, in respective structures of the mobile radio telephone P2, the same symbols as the mobile radio telephone P1 are affixed to the constituent portions having the structures similar to the above mobile radio telephone P1, and their explanation will be omitted herein to avoid the redundancy of explanation.

The mobile radio telephone P2 is constructed by providing the pilot switch 24 in place of the pilot switch 9 and the pilot switch 10, out of respective constituent portions of the mobile radio telephone P1 in the above-mentioned first embodiment, to detect the turn of the antenna 4. As shown in FIGS. 4B and 4C, the pilot switch 24 consists of an antenna holding portion 24a formed of the elastic material such as the rubber, etc., and a pushing detecting element 24b formed of a plurality of pressure sensors, etc. for sensing the pressure by the antenna holding portion 24a. In this case, assume that the pushing detecting element 24b consists of four pressure sensors herein.

The antenna holding portion 24a is arranged in the hollow portion of the hollow cylinder portion 3a and a part thereof is fitted into the hollow cylinder portion 3a such that the metal rod 4b can be elastically held at the center of the hollow cylinder portion 3a by the elasticity of the part of the antenna holding portion 24a itself in the state that the metal rod 4b is inserted loosely into the hollow cylinder portion 3a. Also, as shown in FIG. 4C, in the antenna holding portion 24a, clearances are formed between inner wall surfaces of the hollow cylinder portion 3a in four directions along the X-Y orthogonal axes. In addition, four pushing detecting elements 24b are installed into the clearances on the inner wall surface side of the hollow cylinder portion 3a respectively. The pushing detecting element 24b and the antenna holding portion 24a are arranged respectively to have an almost equal clearance between them when the antenna 4 is not moved or turned.

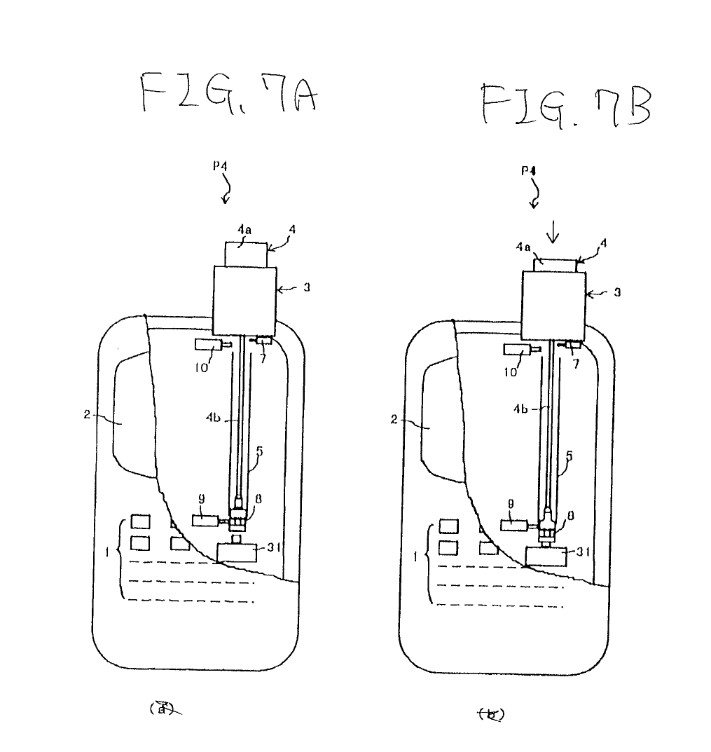

The pilot switch 24 is constructed as above. For example, if the metal rod 4b of the antenna 4 is bent by the user in a certain direction, such metal rod 4b is moved in the same direction in the X-Y plane as the direction along which the metal rod 4b is bent, as shown in FIG. 7C, because a part of the antenna holding portion 24a is deformed correspondingly while having the elasticity. As a result, since the antenna holding portion 24a pushes the pushing detecting element 24b that is present in such moving direction, the pushing detecting element 24b generates the detection output in response to the magnitude of the pushing force.

Since four pushing detecting elements 24b are arranged on the X-Y axes, a positive vector component on the X axis, a negative vector component on the X axis, a positive vector component on the Y axis, and a negative vector component on the Y axis out of the force pushed by the antenna holding portion 24a can be detected respectively. Therefore, since the control portion (not shown) of the telephone P4 synthesizes the detection outputs of these pushing detecting elements 24b, it can detect the direction on the X-Y plane on which the antenna holding portion 24a is moved.

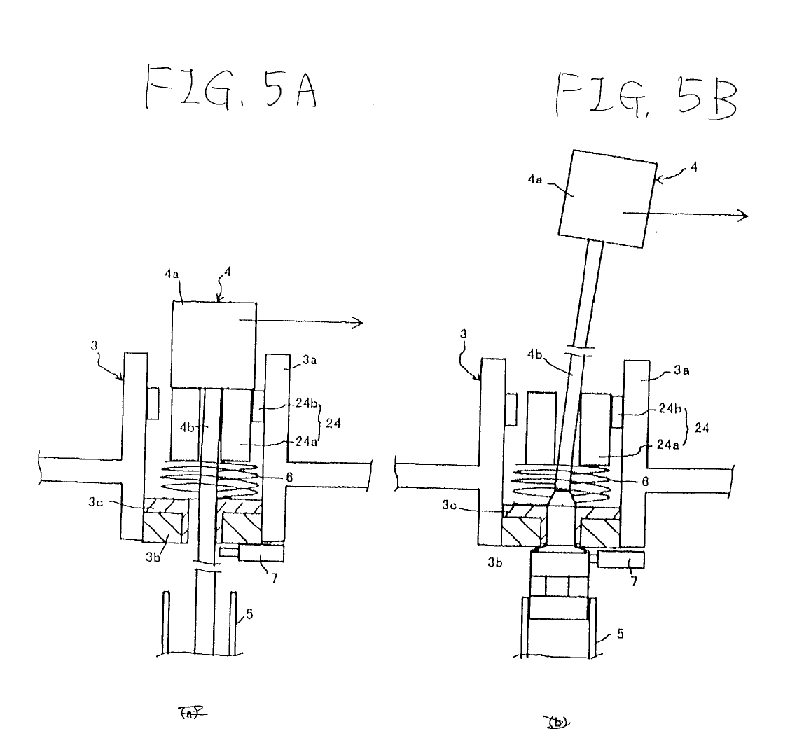

FIGS. 5A and 5B are views showing the pilot switch 24 when the antenna 4 is pushed by the user in the positive direction of the X axis shown in FIG. 4C. FIG. 5A shows the pilot switch 24 which is pushed by the antenna 4 that is positioned at the antenna folding position, and FIG. 5B shows the pilot switch 24 which is pushed by the antenna 4 that is positioned at the antenna extending position. In FIGS. 5A and 5B, when the antenna 4 is pushed in the positive direction of the X axis, the metal rod 4b is bent in the positive direction of the X axis to move the antenna holding portion 24a in the same direction. Thus, since only the pushing detecting element 24b, that is arranged in the positive direction of the X axis, out of four pushing detecting elements 24b receives the force and is pushed, such pushing detecting element 24b can output the detection output in response to the pushing force.

Accordingly, in the case of FIGS. 5A and 5B, because the control portion can detect only the detection output from the pushing detecting element 24b arranged in the positive direction of the X axis, it can detect that the antenna 4 is moved in the positive direction of the X axis and also can detect the amount of movement of the antenna 4 in the positive direction of the X axis.

As can be seen from FIGS. 5A and 5B, after the user positions the antenna 4 at the desired position between the antenna folding position and the antenna extending position, he or she can execute the operation to move the antenna 4 in the direction perpendicular to the above turning axis of the antenna 4.

With the above, according to the mobile radio telephone P2, since the movement in the direction perpendicular to the turn angle can be detected by the pilot switch 24 and then the control portion (not shown) of the telephone P2 executes the control based on the detection results of respective pushing detecting elements 24b of the pilot switch 24, the function that is correlated with the concerned moving operation of the antenna 4 can be selected and operated.

More particularly, the antenna 4 can move the cursor displayed on the display portion 2 by a desired distance in the desired direction on the display screen by the moving operation of the antenna 4. Therefore, only two directions are selected simultaneously as the selection object in the turning operation of the antenna 4, whereas the information can be selected simultaneously in response to the four directions and the four pushing amount or more in this case. As a result, the finer selection of the information can be achieved.

In addition, in the mobile radio telephone P2, the vertical movement of the antenna 4 can be detected by the pilot switch 7 provided to the telephone P2, like the case of the mobile radio telephone P1 in the first embodiment. The redundant explanation of such detecting operation will be omitted herein.

In the above embodiments, it is detected by the pilot switch 7 provided near the upper end of the slide guide 5 in the telephone whether or not the antenna 4 is positioned at the antenna extending position, and then the vertical movement of the antenna 4 is detected based on the detection result. But the present invention is not limited to this. As shown in a mobile radio telephone P3 according to a third embodiment shown in FIG. 3, the vertical movement of the antenna 4 may be detected by a pilot switch 30 provided near the lower end of the slide guide 5 in the telephone P3.

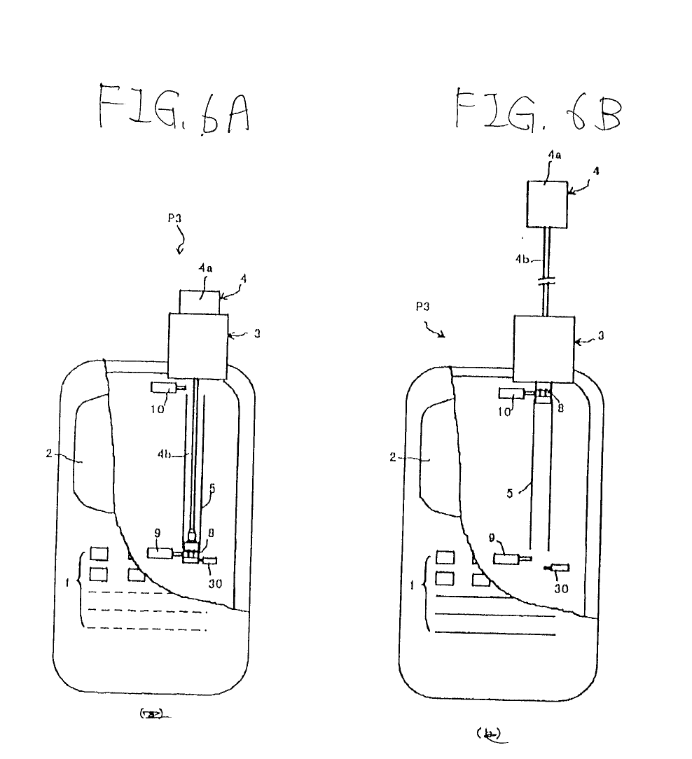

FIGS. 6A and 6B are views showing a mobile radio telephone P3 as a communication device according to a third embodiment of the present invention. FIG. 6A is a view showing the mobile radio telephone P3 together with the inside of the device when the antenna is positioned at the antenna folding position, and FIG. 6B is a view showing the mobile radio telephone P3 together with the inside of the device when the antenna is positioned at the antenna extending position.

The mobile radio telephone P3 is constructed by providing the pilot switch 30 instead of the pilot switch 7 in the above configuration of the mobile radio telephone P1. Accordingly, in the configuration of the mobile radio telephone P3, the same references as the mobile radio telephone P1 are affixed to the constituent portions similar to the mobile radio telephone P1, and thus their redundant explanation of such constituent portions will be omitted herein. Mainly the pilot switch 30 is explained hereunder.

In the mobile radio telephone P3 in FIGS. 6A and 6B, the pilot switch 30 is the ON/OFF switch that is similar to the above pilot switch 7 in the mobile radio telephone P1, and provided near the lower end of the slide guide 5 in the inside of the telephone P3. As shown in FIG. 6A, when the antenna 4 is positioned at the antenna folding position, the pilot switch 30 is pushed by the lower end portion of the antenna 4 and is brought into its ON state. Therefore, the control portion (not shown) of the telephone can detect that the antenna 4 is positioned at the antenna folding position, by detecting this state.

Also, if the antenna 4 is moved from the antenna folding position to the upper antenna extending position, such a situation is released that the lower end portion of the antenna 4 pushes the pilot switch 30. Therefore, the pilot switch 30 is turned OFF.

Consequently, the control portion can perform the functions similar to the above pilot switch 7 and described in the following, in response to the detection result of the pilot switch 30.

(Functions in Response to the Vertically Moving Operation of the Antenna 4)

(1) Talking function in the call outgoing and the call incoming of the telephone:

When the call made by the ringing tone from the telephone of the other party is accepted by the telephone P3 whose antenna is pushed into the antenna folding position and which is set in the standby state of the telephone, the user pulls out the antenna 4 in response to this call and thus the pilot switch 30 can be switched from ON to OFF. Since the control portion connects the line to the calling telephone of the other party to talk with the other party in response to the output result of the pilot switch 30 in this case, the pilot switch 30 can be employed in the talking function at the time of the call incoming. As a result, the user can talk with the other party without the separate operation to push the talk button.

Also, when the user calls the desired other party, the pilot switch 30 can be switched from ON to OFF because the user executes the pulling operation to pull out the antenna 4 to the antenna extending position. Therefore, since the control portion issues the call to the telephone of the designated destination in response to the output result of the pilot switch 30 in this case, the pilot switch 30 can be employed in the talking function at the time of the call outgoing. As a result, the user can talk with the other party by calling the telephone of the other party without the separate operation to push the talk button.

(2) Function for interrupting the telephone line during talking:

When the user executes the operation to push the antenna 4 from the antenna extending position into the antenna folding position of the telephone P3, for example, during the talking with the other party, the pilot switch 30 can be switched from OFF to ON. Therefore, the control portion interrupts the line between the mobile radio telephone P3 and the telephone of the destination in response to the output result of the pilot switch 30 in this case. As a result, without the separate operation of the power button to turn OFF the power supply, the user can interrupt easily the telephone P3 from the talking other party by performing the simple operation to push the antenna 4 from the antenna extending position into the antenna folding position in the inside of the telephone P3 during the talking with the destination.

Next, a principal structure that enables to detect whether or not the antenna 4 is moved to a predetermined position lower than the antenna folding position will be explained with reference to a fourth embodiment in FIGS. 7A and 7B hereunder.

FIGS. 7A and 7B are views showing a mobile radio telephone P4 according to a fourth embodiment of the present invention. FIG. 7A is a view showing the mobile radio telephone P4 together with the inside of the device when the antenna 4 is positioned at the antenna folding position, and FIG. 7B is a view showing the mobile radio telephone P4 together with the inside of the device when the antenna 4 is positioned at the antenna extending position.

The mobile radio telephone P4 is constructed by providing a pilot switch 31 in addition to the configuration of the mobile radio telephone P1 (see FIGS. 1A to 1C) in the above-mentioned first embodiment.

Accordingly, in the configuration of the mobile radio telephone P4, the same references as the mobile radio telephone P1 are affixed to the constituent portions similar to the mobile radio telephone P1, and thus their redundant explanation of such constituent portions will be omitted herein. Mainly the pilot switch 31 is explained hereunder.

In FIGS. 7A and 7B, the pilot switch 31 is a push switch that detects ON/OFF and is provided near the lower end of the slide guide 5. When the antenna 4 is positioned at the antenna folding position, the pilot switch 31 is separated from the lower end portion of the antenna 4 and is in its OFF state. If the user pushes the head portion 4a of the antenna 4, that is positioned at the antenna folding position, to move the antenna 4 to the predetermined position lower than the antenna folding position, the lower end portion of the antenna 4 pushes the pilot switch 31 so as to bring the pilot switch 31 into its ON state.

Also, if the user releases the operation to push the antenna 4 that is positioned at the antenna folding position, the head portion 4a of the antenna 4 is pushed back by the restoring force of the spring 6 provided to the hollow cylinder portion 3a of the guide portion 3. Therefore, the antenna 4 can be positioned at the antenna folding position and also the lower end portion of the antenna 4 is released to push the pilot switch 31, and thus the pilot switch 31 is brought into its OFF state. Accordingly, while the pilot switch 31 is detecting its ON, the control portion (not shown) of the telephone P4 can decide based on the detection output of the pilot switch 31 that the antenna 4 is positioned at the predetermined position lower than the antenna folding position.

Consequently, the control portion can perform the functions described in the following, in response to the detection result of the pilot switch 31.

More particularly, if the control portion detects that the pilot switch 31 is switched from OFF to ON when the power supply of the telephone P4 is OFF, such control portion executes the operation to switch the power supply of the telephone P4 from OFF to ON. In contrast, if the control portion detects that the pilot switch 31 is switched from OFF to ON when the power supply of the telephone P4 is ON, such control portion executes the operation to switch the power supply of the telephone P4 from ON to OFF.

As a result, the user wishes to call the desired destination by employing the telephone P4 in which the antenna 4 is positioned at the antenna folding position and the power supply is in the inoperative OFF state, for example, such user can bring the power supply into its ON state by executing the operation to push the head portion 4a of the antenna 4 into the inside.

Also, if the user releases the operation to push the head portion 4a of the antenna 4 into the inside, the antenna 4 can be pushed back to the antenna folding position again by the spring 6. Therefore, the user can scroll-select the telephone number of the desired destination from the telephone directory list, that is displayed on the display portion 2 at that time, by turning appropriately the antenna 4 that is positioned at the antenna folding position. In addition, if the user pulls out the antenna 4 to the antenna extending position subsequently to the selection of the telephone number of the destination, the pilot switch 7 can be switched from OFF to ON. Therefore, the control portion can issue the call to the telephone of the destination designated by the selection, in response to the output result of the pilot switch 30 in this case.

That is, the user can easily apply a series of operations in connection with the start of the communication with the destination, e.g., the operation for turning ON the power supply, the operation for designating the telephone number of the destination, the communication operation by calling the destination, etc., to the telephone P4 that is set in its inoperative state, by merely operating the antenna 4 as the selecting means.

Further, for example, if the user wishes to terminate the talking with the destination and to bring the telephone P4 into the state that the antenna 4 is positioned at the antenna folding position and the power supply is set in the inoperative OFF state, the user executes the operation to push the antenna 4, that is positioned at the antenna extending position, into the inside of the device and thus the lower end portion of the antenna 4 can push the pilot switch 31 to switch it from OFF to ON. Accordingly, the power supply of the telephone P4 is switched from ON to OFF. Also, if the user releases the operation to push the head portion 4a of the antenna 4 into the inside, the antenna 4 can be pushed back to the antenna folding position again by the spring 6.

That is, the user can easily apply a series of operations in connection with the termination of the communication with the destination, e.g., the operation for pushing the antenna 4 into the antenna folding position, the operation for turning OFF the power supply, etc., to the telephone P4 in which the antenna 4 is pulled out to the antenna extending position and which is set in its communication state with the destination, by only operating the antenna 4 as the selecting means.

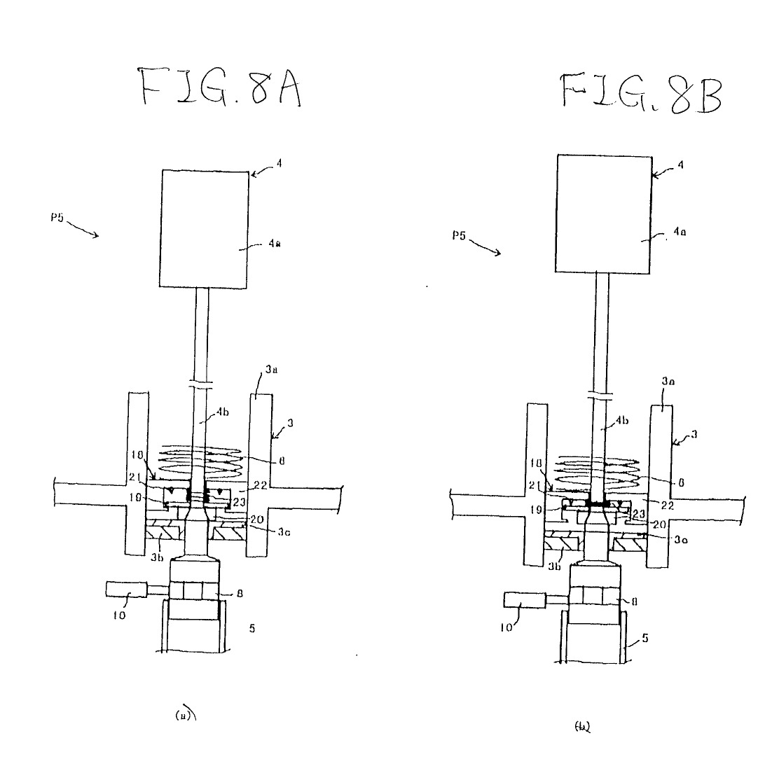

Next, a principal structure that enables to detect whether or not the antenna 4 is moved to a predetermined position upper than the antenna extending position will be explained with reference to a fifth embodiment in FIGS. 8A to 8C hereunder.

FIGS. 8A and 8B are views showing a principal structure around a pilot switch 18 of a mobile radio telephone P5 according to a fifth embodiment of the present invention. FIG. 8A shows a principal structure of the pilot switch 18 of the mobile radio telephone P5 when the antenna 4 is positioned at the antenna extending position, and FIG. 8B shows a principal structure of the pilot switch 18 of the mobile radio telephone P5 when the antenna 4 is pulled out further more by a predetermined distance from the antenna extending position.

The mobile radio telephone P5 is constructed by providing the pilot switch 18 in addition to the configuration of the mobile radio telephone P3 in the above-mentioned third embodiment. Accordingly, in the configuration of the mobile radio telephone P5, the same references as above the mobile radio telephone P3 are affixed to the constituent portions similar to the mobile radio telephone P3, mainly the configuration and the operation of the pilot switch 18 in the mobile radio telephone P5 will be explained hereunder. Since other constituent portions are similar to those in the mobile radio telephone P3, their redundant explanation will be omitted herein.

The pilot switch 18 is provided between the spring 6 in the hollow cylinder portion 3a of the guide portion 3 and a fitting screw 3c of the mobile radio telephone P5. The spring 6 is fitted to a top surface of the pilot switch 18, and also the pilot switch 18 is fitted to a top surface of the fitting screw 3c. The pilot switch 18 detects that the antenna 4 is pulled out from the antenna extending position to the predetermined upper position. Also, if the user stops the operation to pull the antenna 4 further upwardly from the antenna extending position, the pilot switch 18 pulls back the antenna 4 to the antenna extending position and is then restored into its initial state by itself.

As shown in FIGS. 8A and 8B, the pilot switch 18 consists of a moving portion 20 formed of conductive metal and having a contact 19, a fixing portion 22 having a contact 21, and a coil spring 23. Holes are provided in the center portions of the moving portion 20 and the fixing portion 22, and the metal rod 4b of the antenna 4 pass slidably through the holes. The moving portion 20 formed of metal that has a shape that can be fitted/released into/from the lower end portion of the metal rod 4b. The moving portion 20 and the fixing portion 22 are arranged such that the contact 19 and the contact 21 oppose to each other, and the compressed spring 23 is arranged between the contact 19 of the moving portion 20 and the contact 21 of the fixing portion 22 to pass through the metal rod 4b.

In the pilot switch 18, in the initial state shown in FIG. 8A, the moving portion 20 latches the fixing portion 22 by the restoring force of the spring 23. Thus, since the contact 19 and the contact 21 are connected to each other in this state, the pilot switch 18 is set to its OFF state. Also, if the lower end portion of the metal rod 4b of the antenna 4 is fitted into the moving portion 20, the pilot switch 18 places the antenna 4 to the antenna folding position by the restoring force of the spring 23, as shown in FIG. 6A, and is then restored into its initial state by itself.

Also, when the antenna 4 is pulled out upwardly much more from the antenna extending position by the user, for example, in the situation that the antenna 4 is positioned at the antenna extending position, the moving portion 20 is pushed upward by the lower end portion of the metal rod 4b of the antenna 4. Therefore, the spring 23 is compressed much more and also the contact 19 is moved upwardly. As a result, when the antenna 4 is moved to the upward predetermined position rather than the antenna extending position, the contact 19 and the contact 21 are connected in the state that the spring 23 is compressed, as shown in FIG. 8B, and thus switch is brought into its ON state.

At this time, since the control portion of the telephone P5 detects that the pilot switch 18 is in its ON state, it can detect that the antenna 4 is moved to the upward predetermined position rather than the antenna extending position.

Also, when the user stops the operation to pull out the antenna 4 further from the antenna extending position, the moving portion 20 as well as the antenna 4 is pushed back downwardly by the restoring force of the spring 23. Therefore, the antenna 4 is moved to the antenna extending position and also the pilot switch 18 is then restored into its initial OFF state by itself.

Accordingly, in the mobile radio telephone P5, because the pilot switch 18 is switched from OFF to ON, the movement of the antenna 4 in the vertical direction can be detected. Also, because the control portion (not shown) of the telephone P5 executes the control based on the detection result of the pilot switch 18, the functions which are correlated with the moving operation of the antenna 4 to turn the pilot switch 18 ON/OFF can be selected and operated.

More particularly, the controlling operation can be performed such that, when the pilot switch 18 is turned ON, the control operation can switch the state of the power supply of the telephone P5. Accordingly, the user wishes the power supply of the telephone P5 from the ON state to the OFF state, he or she can turn the pilot switch 18 ON by simply executing the operation to pull out the antenna 4, that is positioned at the antenna extending position, further toward the direction opposite to the antenna folding position and then the control portion can change the power supply of the telephone P5 from the ON state to the OFF state by detecting this.

Also, for example, in order to turn the power supply of the telephone into the inoperative state during talking, the user wishes to turn the power supply OFF and to push the antenna 4 into the antenna folding position, the user pulls out the antenna 4, that is positioned at the antenna extending position, from the antenna extending position to the upper predetermined position. Thus, the power supply is switched into its OFF state, and also the antenna 4 is pulled back to the antenna extending position again by the restoring force of the spring 23.

That is, for example, in the telephone P5 that can talk with the other party, if the user executes the simple operations of the antenna 4 that pushes forcibly toward the antenna folding position following to the operation that pulls out the antenna 4 from the antenna extending position to the upper predetermined position, he or she can push the antenna 4 in the antenna folding position and can turn easily the power supply OFF without the pushing of the power button provided separately to the key pad 1.

Also, for example, if the user wishes to switch the power supply of the telephone P5, that is in the OFF state, into the ON state, the pilot switch 18 can be turned ON by moving the antenna 4, that is positioned at the antenna folding position, from the antenna extending position to the upper predetermined position, and then the power supply of the telephone P5 can be switched from the OFF state to the ON state by detecting this by the control portion. Also, the antenna 4 is pulled back to the antenna extending position again by the restoring force of the spring 23.

Accordingly, if the user applies the simple pulling-out operation of the antenna 4, that pulls out the antenna 4 from the antenna extending position to the upper predetermined position, for example, to the telephone P5 whose antenna 4 is positioned at the antenna folding position and whose power supply is set in the inoperative OFF state, he or she can pull out the antenna 4 to the antenna extending position and can turn easily the power supply ON without the pushing of the power button provided separately to the key pad 1.

In the state that the antenna 4 is pulled out to the antenna extending position, the pilot switch 7 is turned ON and also the lever 11 of the pilot switch 10 engages with the star gear 8. Therefore, if the user displays the telephone directory list on the display portion 2 by using the telephone directory function, he or she can scroll-search the information about the telephone of the destination by turning the antenna 4. It is needless to say that, if there is the telephone number designated and stored in the telephone P5 previously or the telephone number designated according to the result of the scroll search by the turn of the antenna 4, the control portion can issue the call to the telephone of the destination having the concerned telephone number.

In the mobile radio telephone P5, in addition to this, the movement of the antenna 4 can be detected by the pilot switch 30, the pilot switch 9, and the pilot switch 10 provided to the telephone P5, like the case of the mobile radio telephone P3 in the third embodiment. The redundant explanation of such detecting operation will be omitted herein.

With the above, because the control portion (not shown) of the telephone P5 executes the control based on the detection result of the detecting means, the functions which are correlated with the above moving operations of the antenna 4 can be selected and operated.

In the mobile radio telephone P4 in the above fourth embodiment, it is possible to detect that the antenna 4 is moved to the predetermined position lower than the antenna folding position by detecting that the pilot switch 31 is switched from OFF to ON, the control portion executes the switching operation of the power supply in response to the detection result. Also, it is possible to detect that the antenna 4 is moved to the predetermined position lower than the antenna folding position and that the antenna 4 is positioned subsequently to the antenna folding position, by detecting that the pilot switch 31 is switched from OFF to ON. This is because, after the antenna 4 is moved to the predetermined position lower than the antenna folding position, the antenna 4 can be restored to the antenna folding position again by the restoring force of the spring 6 when the user stops the operation to push the antenna 4.

In the mobile radio telephone P5 in the above fifth embodiment, it is possible to detect that the antenna 4 is moved to the predetermined position upper than the antenna extending position by detecting that the pilot switch 18 is switched from OFF to ON, the control portion executes the switching operation of the power supply in response to the detection result. Also, it is possible to detect that the antenna 4 is moved to the predetermined position upper than the antenna extending position and that the antenna 4 is positioned subsequently to the antenna extending position, by detecting that the pilot switch 18 is switched from OFF to ON. This is because, after the antenna 4 is moved to the predetermined position upper than the antenna extending position, the antenna 4 can be restored to the antenna folding position again by the restoring force of the spring 6 when the user stops the operation to pull out the antenna 4.

In the mobile radio telephones in the above embodiments, there is provided any one pilot switch of the pilot switch 30 for detecting the antenna folding position of the antenna 4 and the pilot switch 7 for detecting the antenna extending position of the antenna 4 in the vertical direction of the antenna 4. Both the pilot switch 30 and the pilot switch 7 may be provided to detect that the antenna 4 is positioned at the antenna folding position and the antenna extending position, by the pilot switch 30 and the pilot switch 7 respectively.

In the above embodiment, the scrolling function of the telephone directory list is explained as an example of the function that is correlated with the turn operation of the antenna 4. But the present invention is not limited to this, and any function may be employed if a plurality of information can be selected by one function. For example, the area selection of the display screen which can be changed into a plurality of display areas (screen scroll), the level selection of the volume which can be changed into a plurality of levels (volume control), the brightness level selection of the display screen which can be changed into a plurality of levels (brightness control), etc. may be performed in response to the turn operation of the antenna.

Also, the information can be selected in response to the turning speed of the antenna such that the desired information can be selected effectively from a large number of information. For example, in the case of the data input of the calendar, the time input of the watch, the character input of the mail, etc., there exist many alphanumeric characters as the selective object. At this time, if the alphanumeric characters are arranged previously in the predetermined order (alphabetical order, Japanese syllabary order, etc.), the user can easily recognize whether or not the order to select the desired alphanumeric character is close or far. As a result, the user can accelerate the turning speed to feed quickly the order if the order of the desired alphanumeric character is far, whereas the user can decelerate the turning speed to select firmly the alphanumeric character if the order of the desired alphanumeric character is close.

Further, the type of the selection object may be differentiated according to the direction of the turn operation of the antenna. For example, the telephone number search for redial may be executed if the antenna is turned clockwise, and the telephone number search for memory dial may be executed if the antenna is turned anticlockwise.

Furthermore, a plurality of types of information may be selected by using a combination of the turn motion and the vertical moving motion of the antenna. For example, in the case of the mobile telephone that can be connected to the Internet, URL may be selected by the turn motion of the antenna, then the connection to the selected URL may be started by the vertical moving motion, and then the turn motion of the antenna may be switched to scroll the display screen of the destination after the connection. Also, in the case of the mobile telephone that can play the audio such as the music, etc., the title of the music may be selected according to the turning direction and the amount of turn of the antenna, then the playback and the stop may be executed by the vertical moving motion of the antenna, and then the turn motion of the antenna is correlated to the playback speed during the playback.

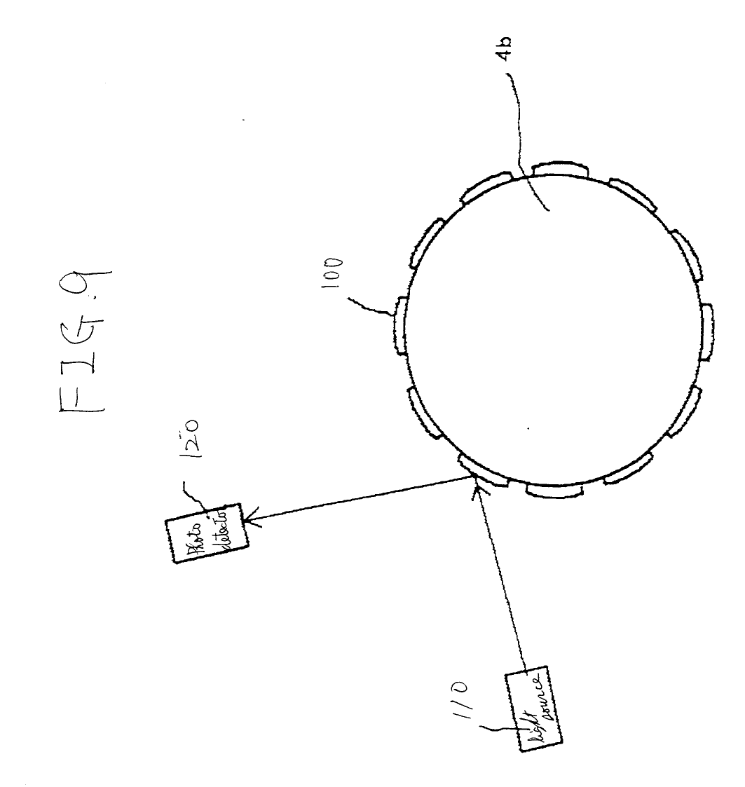

Moreover, the antenna turn detecting means is not limited to the mechanism employing the star gear 8 and the pilot switch 9 (or the pilot switch 10) in the first embodiment. Any mechanism may be employed if it can detect the turn at respective moving positions of the antenna 4 in the vertical direction. For example, like the turn detecting means in the present invention shown in FIG. 9 and others, if reflection mirrors 100 are formed at equal intervals around the side surface of the metal rod 4b and then the light emitted from a light source 110 provided to the device is reflected by the reflection mirror 100 and then received by a photo detector 120, the photo detector can receive the optical pulses of the reflected light, whose pulse number corresponds to the amount of turn of the antenna 4, when the antenna 4 is turned. Therefore, the turn of the antenna 4 and the amount of turn can be detected.

In the present embodiment, the antenna that can be turned infinitely in two directions is explained as an example. The antenna that can be turned in one direction, the antenna in which the amount of turn is limited, e.g., the antenna that can be turned by a half turn, etc. may be employed.

In the above embodiment, the mobile radio telephone having the antenna is explained as the communication device. The communication device in the present invention is not limited, and all the communication devices may be selected as the object if the communication device can communicate via the antenna.

Therefore, the present invention can select effectively a plurality of types of information by utilizing the structure of the antenna. In particular, if the information concerning to the communication are selected, the user can select the information by the turning motion, etc. of the antenna and then can pull out the antenna as it is, and therefore the user can execute easily a series of operations in connection with the communication merely by the operation of the antenna. As a result, the convenience in operation for the user is increased and the quick operation can be executed rather than the prior art.

What is claimed is:

1. A communication device comprising:
an antenna;
an antenna supporting portion for rotatably supporting said antenna in said communication device;
a gear provided coaxially and integrally with said antenna; and
a turn detector engaged with said gear for detecting a turn of said antenna.

2. A communication device according to claim 1, further comprising:
a housing portion for receiving said antenna into the inside of said communication device; and
wherein said gear engages with said turn detector in a state where said housing portion receives said antenna and a state where said housing portion does not receive said antenna.

3. A communication device comprising:
an antenna movably supported in the communication device;
a movement detector for detecting a movement of said antenna; and
a selector for selecting information in response to a moving direction or an amount of movement of said antenna based on a movement detected result.

4. A communication device comprising:
an antenna rotatably supported in the communication device;
a turn detector for detecting a turn of said antenna; and
a selector for selecting information in response to a turning direction or an amount of turn or a turning speed of the antenna based on a turn detected result.

5. A communication device comprising:
an antenna movably supported in the communication device;
a movement detector for detecting a movement of said antenna;
a searching device for searching information in response to a turning direction or an amount of turn or a turning speed of said antenna based on a turn detected result; and
a selector for selecting information in response to a moving direction or an amount of movement of the antenna in a turning axis direction based on a movement detected result.

6. A communication device according to any one of claims 3 to 5, wherein communication is carried out in response to the selection of the information by said selector.
